(19) United States
(12) Patent Application Publication
(10) Pub. No.: US 2012/0154419 A1
(43) Pub. Date: Jun. 21, 2012

(54) IMAGE OUTPUT DEVICE, IMAGE OUTPUT METHOD, AND IMAGE DISPLAY APPARATUS

(76) Inventors: Minehisa Nagata, Osaka (JP); Masaya Yamamoto, Kanagawa (JP); Shunji Harada, Osaka (JP); Ryota Tsukidate, Osaka (JP); Ryuji Inoue, Osaka (JP)

(21) Appl. No.: 13/393,663

(22) PCT Filed: Jun. 29, 2011
(86) PCT No.: PCT/JP2011/003701

§ 371 Date: Mar. 1, 2012

(30) Foreign Application Priority Data
Jul. 2, 2010 (JP) 2010-151611

(51) Int. Cl. G09G 5/00

(52) U.S. Cl. 345/581

(57) ABSTRACT

An image output device includes a receiving unit which receives first input information including position information indicating a position on a display image, an attribute information selecting unit which selects first attribute information corresponding to the position indicated by the position information and is one of pieces of attribute information associated with the displayed image from among the pieces of attribute information, an image selecting unit which selects images having attribute information corresponding to the first attribute information from among images including the displayed image, a display sequence determining unit which determines the display sequence of the images based on the attribute information of each of the images selected by the image selecting unit, and an output unit which acquires and outputs the images such that the selected images are displayed in the determined display sequence on a display device.

### TECHNICAL FIELD

The present invention relates to an image output device and an image output method for displaying a plurality of stored images consecutively.

### BACKGROUND ART

A conventional image display device exists which display images meeting a predetermined condition, such as images which a user wishes to view by selecting and displaying images corresponding to a person or a part of the scenery as a result of a user selecting a person or that part of the scenery in the displayed image (for example see PTL 1).

FIG. 18 is a diagram showing a configuration of a conventional image display device disclosed in PTL 1.

In the image display device 1710 shown in FIG. 18, images included in the stored group of images are displayed on a touch panel and display unit 1716. By touching the touch panel and display unit 1716, a user can select a desired type of subject such as a person or scenery from a plurality of subjects in the displayed image. A viewer reaction determination unit 1718 extracts an image containing the type of subject selected by a user from the group of images. The priority changing unit then places priority on the extracted image over the images other than those which contain the type of subject selected and displays the extracted images on the touch panel and display unit 1716.

### CITATION LIST

### [Patent Literature]

[PTL 1] Japanese Unexamined Patent Application Publication No.

### SUMMARY OF INVENTION

### Technical Problem

However, according to the conventional technique exemplified above, a problem arises in which a user must touch the image once again to display a next image, burdening a user with constant operation and an inefficient image selection process.

Moreover, according to the conventional configuration exemplified above, because images cannot be selected for display using a combination of selection conditions, images cannot be narrowed down based on a plurality of conditions and displayed. In other words, a problem arises in which the process of selecting an image that meets a given condition among a plurality of images cannot be efficiently executed.

Accordingly, the object of the present invention is to solve the problems associated with the conventional configuration described above by providing an image output device, an image output method, and an image display device in which the image output device is included, the image output device being a device for displaying a group of stored images consecutively which can efficiently select and output images which meet a given condition from a plurality of images.

### Solution to Problem

In order to solve these problems, the image output device according to an aspect of the present invention includes a receiving unit configured to receive first input information which includes position information indicating a position on a display image that is an image displayed on a display device connected to the image output device, an attribute information selecting unit configured to select, as first attribute information, one of a plurality of pieces of attribute information associated with the display image, the first attribute information corresponding to the position indicated by the position information, an image selecting unit configured to select a plurality of images each having a piece of attribute information corresponding to the first attribute information from among a plurality of images including the display image stored in a storage device connected to the image output device, a display sequence determining unit configured to determine a display sequence of the plurality of images selected by the image selecting unit based on the attribute information of each of the plurality of images, and an output unit configured to obtain, from the storage device, the plurality of images selected by the image selecting unit and output the plurality of images such that the plurality of images are displayed on the display device in the display sequence determined by the display sequence determining unit.

With this configuration, the first attribute information is selected based on the position on the display image indicated by the position information, and a plurality of images corresponding to the first attribute information are selected. Moreover, a display sequence of the selected plurality of images is determined based on the attribute information of each of the plurality of images, and the plurality of images are output such that they are displayed in the display sequence.

In other words, according to this aspect of the image output device, by using the first attribute information which is based on a position on the display image, a plurality of images which have common attribute information can be selected with efficiency as well as displayed consecutively.

Moreover, in the image output device according to an aspect of the present invention, the receiving unit may further be configured to receive second input information which includes position information indicating a position on the display image, the second input information being different in content from the first input information, the attribute information selecting unit is further configured to select, as second attribute information, one of the plurality of pieces of attribute information associated with the display image, the second attribute information corresponding to the position information included in the second input information, and the image selecting unit may be configured to select, from among the plurality of images stored in the storage device, a plurality of images each having a piece of attribute information corresponding to the first attribute information and a piece of attribute information corresponding to the second attribute information.

According to this configuration, among the plurality of images subject to selection, the plurality of images corresponding to both the first attribute information and the second attribute information are selected. In other words, according to this aspect of the image output device, the images can be efficiently narrowed down to images to be shown.

Moreover, in the image output device according to an aspect of the present invention, the image selecting unit may be configured to select, from among a plurality of images stored in the storage device, a second group of images when after selecting a first group of images the number of images in the first group of images is a given number or less, the first group of images including a plurality of images each having a piece of attribute information corresponding to the first attribute information and a piece of attribute information corresponding to the second attribute information, and the second group of images including a plurality of images each having a piece of attribute information corresponding to the second attribute information.

According to this configuration, when the number of images corresponding to both the first attribute information and the second attribute information is small, images corresponding only to the second attribute information can be selected as a condition for selection. This allows for efficient selection of, for example, an appropriate type and number of images.

Moreover, in the image output device according to an aspect of the present invention, the display sequence determining unit may be configured to determine a display sequence of the second group of images and skip the determination of the display sequence of the first group of images when the second group of images is selected by the image selecting unit, and the output unit may be configured to obtain, from the storage device, the plurality of images included in the second group of images selected by the image selecting unit and output the plurality of images such that the plurality of images are displayed on the display device in the display sequence determined by the display sequence determining unit.

According to this configuration, images limited to the second group of images corresponding to the second attribute information based on the later of two instructed inputs can be displayed in a given sequence, for instance. This allows for efficient processing relating to displaying, for example, an appropriate type and number of images.

Moreover, in the image output device according to an aspect of the present invention, when the second group of images is selected by the image selecting unit, the display sequence determining unit may be configured to (a) determine a first display sequence of the first group of images, (b) determine a second display sequence of the second group of images, and furthermore (c) determine a final display sequence which is a sequence of the first display sequence and the second display sequence, and the output unit may be configured to obtain, from the storage device, the plurality of images included in both the first group of images and the second group of images selected by the image selecting unit and output the plurality of images such that the plurality of images are displayed on the display device in the final display sequence.

According to this configuration, both the first group of images and the second group of images selected based on two instructed inputs can be displayed in a given sequence, for instance. This, for example, allows for a type and number of images corresponding to the plurality of instructed inputs to be displayed without omission.

Moreover, in the image output device according to an aspect of the present invention, the display sequence determining unit may be configured to determine the display sequence of the plurality of images selected by the image selecting unit based on the attribute information of each of the plurality of images which corresponds to the first attribute information.

According to this configuration, an appropriate display sequence corresponding to the first attribute information used for the selection of the images can be determined with efficiency. In other words, by associating the selection criterion with the criterion for the arrangement of the display sequence, the selected plurality of images can be displayed in an appropriate sequence. As a result, unnecessary processing such as the rearrangement of the display sequence can be avoided.

Moreover, in the image output device according to an aspect of the present invention, the first input information may further include action information indicating a type of action made upon input of the position information into the image output device, and the attribute information selecting unit may be configured to select the first attribute information from the plurality of pieces of attribute information associated with the display image, the first attribute information corresponding to the position information and the action information.

According to this configuration, the first attribute information, which becomes a condition for the selection of images, is selected in accordance with the type of action at the time of position information input. This makes the image selecting process more efficient.

Moreover, in the image output device according to an aspect of the present invention, the first input information may further include action information indicating a type of action made upon input of the position information into the image output device, and the display sequence determining unit may be configured to determine a display sequence of the plurality of images selected by the image selecting unit based on the attribute information of each of the plurality of images and the action information.

According to this configuration, the display sequence of the selected images is determined in accordance with the type of action at the time of position information input. This makes the processing related to the output of the images to be displayed more efficient.

Moreover, in the image output device according to an aspect of the present invention, the attribute information selecting unit may be configured to obtain, from the storage device, information identifying a subject in the display image and information indicating a region on the display image corresponding to the subject, and may be configured to (a) select, as the first attribute information, attribute information specifying the subject when the position indicated by the position information is within the region, and (b) select, as the first attribute information, attribute information specifying a group the display image belongs to when the position indicated by the position information is outside the region.

According to this configuration, the first attribute information, which becomes a condition for the selection of images, is appropriately selected in accordance with the position indicated by the position information from a variety of types of attribute information.

Moreover, the image display device according to an aspect of the present invention displays a plurality of images consecutively and includes the image output device according to any of the preceding aspects and the display device. The display device includes a display unit configured to receive and display the plurality of images output from the output unit in the display sequence determined by the display sequence determining unit and an input information acquisition unit configured to obtain the first input information by receiving a position on the display image, and transmit the obtained first input information which includes position information indicating the position to the receiving unit, the position being specified by a given action made on the image display device.

According to this configuration, images which meet a given criteria can be efficiently selected from a plurality of images and displayed.

The present invention can moreover be realized as an image output method according to any one of the preceding aspects, the image output method including a characteristic process executed by the image output device. The present invention can moreover be realized as a computer program for causing a computer to perform processes included in the image output method or as a recording medium having the computer program thereon. The program can then be distributed via a transmission medium such as the Internet or a recording medium such as a DVD.

The present invention can moreover be realized as an integrated circuit according to any of the preceding aspects, the integrated circuit having a characteristic component included in the image output device.

### Advantageous Effects of Invention

With the image output device and the image output method according to the present invention, an image that meets a given condition can be selected and output from a plurality of images. As a result, a user can easily select and display desired images consecutively, as well as select one or more images based on attribute information associated with a plurality of objects and display the selected images consecutively.

### BRIEF DESCRIPTION OF DRAWINGS

FIG. 1 is a block diagram showing the main part of the configuration of the image display device according to the first embodiment of the present invention.

FIG. 2 is a first example of a data structure showing images and their respective attribute information according to the first embodiment of the present invention.

FIG. 3 is a second example of a data structure showing images and their respective attribute information according to the first embodiment of the present invention.

FIG. 4 is a first example of an image stored in the image display device according to the first embodiment of the present invention.

FIG. 5 is a second example of an image stored in the image display device according to the first embodiment of the present invention.

FIG. 6 is a flowchart showing a basic operation performed by the image output device according to the first embodiment of the present invention.

FIG. 7 is a flowchart showing an example of an operation performed by the image display device according to the first embodiment of the present invention.

FIG. 8 is a flowchart showing an example of an operation in a priority display mode performed by the image display device according to the first embodiment of the present invention.

FIG. 9 is a flowchart showing an example of an operation at the time the priority display sequence is determined from the input information of the image display device according to the first embodiment of the present invention.

FIG. 10 is an example of a data structure showing images and their respective attribute information according to the second embodiment of the present invention.

FIG. 11 is a flowchart showing an example of an operation at the time the priority display sequence is determined from the input information of the image display device according to the second embodiment of the present invention.

FIG. 12 is an example of a data structure showing images and their respective display count according to the second embodiment of the present invention.

FIG. 13 is an example of a data structure showing images and their respective level of importance according to the second embodiment of the present invention.

FIG. 14 is a block diagram showing the main part of the configuration of the image display device according to the third embodiment of the present invention.

FIG. 15 is an example of a data structure showing images and their respective rank according to the third embodiment of the present invention.

FIG. 16 is a flowchart showing an example of an operation at the time the priority display sequence is determined from the input information of the image display device according to the fourth embodiment of the present invention.

FIG. 17 is a flowchart showing an example of an operation at the time the priority display sequence is determined from the input information of the image display device according to the fifth embodiment of the present invention.

FIG. 18 is a block diagram showing a configuration of a conventional image display device.

### DESCRIPTION OF EMBODIMENTS

The embodiments of the present invention will be explained below with reference to the attached drawings. The present invention is not at all limited to these embodiments. Various modifications may be carried out which do not depart from the spirit and scope of the present invention.

### First Embodiment

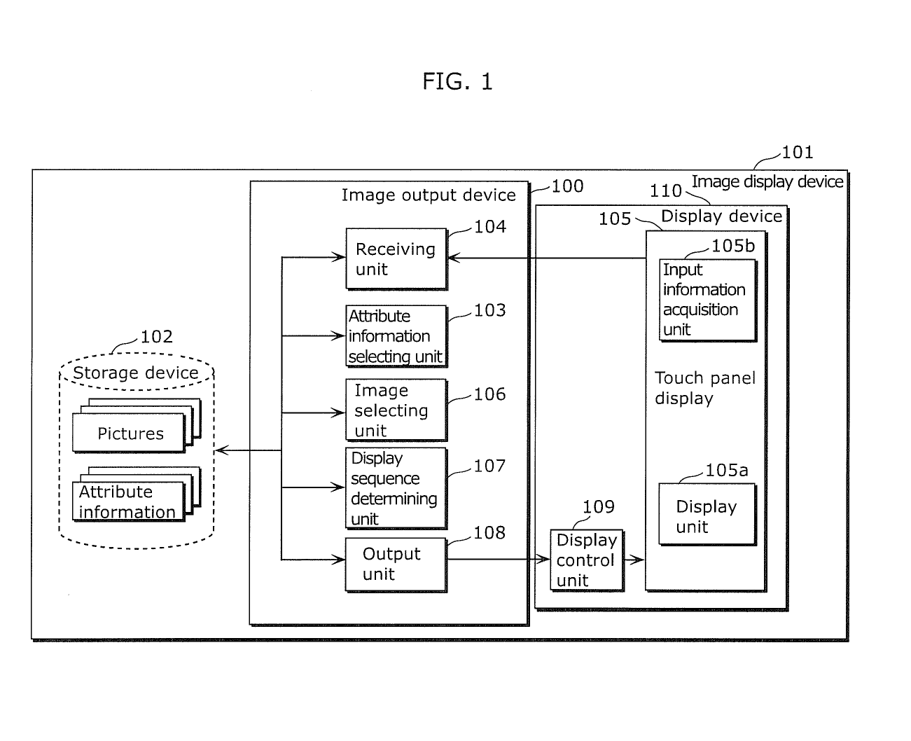

FIG. 1 is a block diagram showing the main part of an image display device 101 according to the first embodiment of the present invention.

The image display device 101 includes an image output device 100, a storage device 102, and a display device 110. The image output device 100 has an attribute information selecting unit 103, a receiving unit 104, an image selecting unit 106, a display sequence determining unit 107, and an output unit 108.

The display device 110 has a display control unit 109 and a touch panel display 105. The touch panel display 105 includes a display unit 105a and an input information acquisition unit 105b. The configurations of the respective components will be explained below.

A storage device 102 stores one or more images each of which is associated with one or more attribute information.

The display device 110 displays an image output from the image output device 100. Specifically, the display control unit 109 receives and renders image data output from the output unit 108 and outputs the image data to the touch panel display 105.

The display unit 105a included in the touch panel display 105 displays an image output by the display control unit 109. Also, when a user makes an action such as touching the touch panel display 105, input information relating to the action is obtained by the input information acquisition unit 105.

In other words, the input information acquisition unit 105 obtains input information by receiving a specification of a position on the display image designated by a given action on the image display device 101.

This input information includes position information indicating a position on the display image being displayed on the display device 110, as well as action information indicating a type of action such as a single tap or double tap. Moreover, according to the first embodiment, information indicating a position on the display image specified by a user touching the touch panel display 105 is obtained as the position information.

The input information obtained from the input information acquisition unit 105b is transmitted to the image output device 100 and received by the receiving unit 104 of the image output device 100.

The display unit 105a is provided, for example, as a flat panel display on the touch panel display 105. Moreover, the input information acquisition unit 105b is provided, for example, using a touch panel on the touch panel display 105 that is touch-sensitive.

The receiving unit 104 transmits the received input information to the attribute information selecting unit 103.

The attribute information selecting unit 103 selects attribute information corresponding to the position information included in the input information from a plurality of pieces of attribute information associated with the display image. The attribute information selecting unit 103 furthermore determines the attribute information which is selected to be selected attribute information and transmits this information to the image selecting unit 106.

The selected attribute information is an example of the first attribute information and the second attribute information in regard to the image output device according to an aspect of the present invention.

The image selecting unit 106 selects, from a plurality of images stored in the storage device 102, a plurality of images based on the selection attribute information and provides the display sequence determining unit 107 with information indicating the plurality of selected images.

The display sequence determining unit 107 determines a display sequence of the plurality of selected images and notifies the output unit 108 of the sequence as a priority display sequence.

The output unit 108 sequentially reads the plurality of images from the storage device 102 and transmits the plurality of images to the display device 110 based on the priority display sequence.

The display device 110 sequentially receives the image data for the plurality of images output from the output unit 108 and displays the images sequentially on the touch panel display 105.

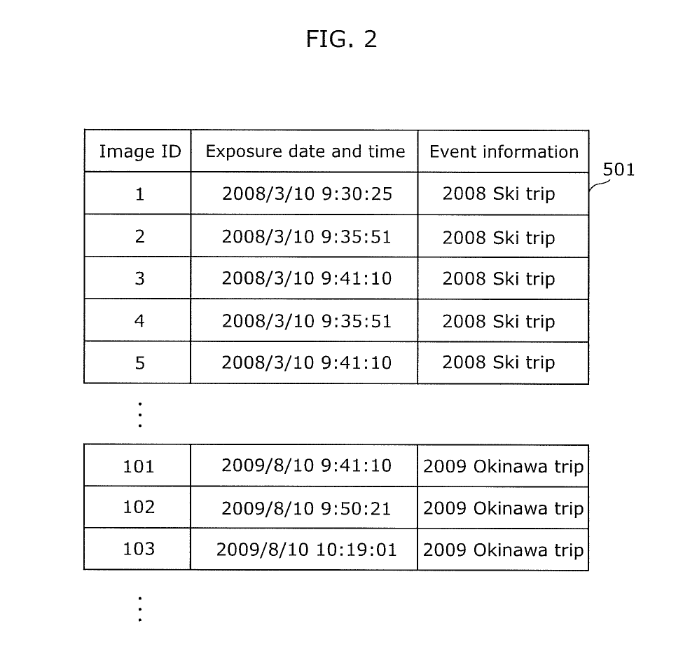

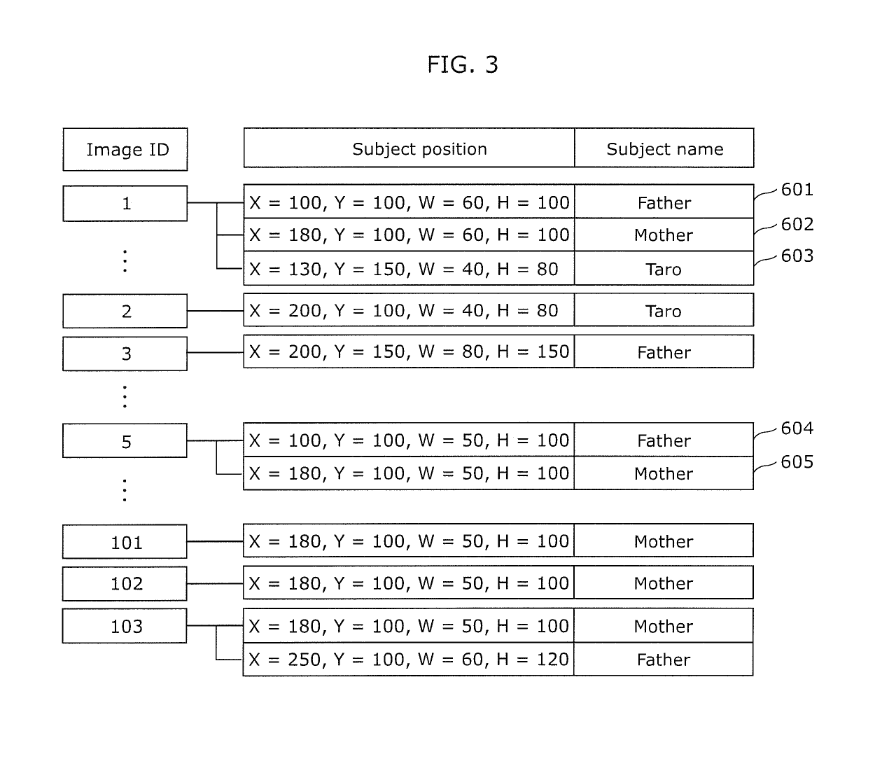

FIG. 2 and FIG. 3 are examples of data structures showing images and their respective attribute information stored in the storage device 102.

As shown in FIG. 2, an image ID for identifying each image, the exposure date and time, and the event information associated with each image ID are stored in the storage device 102.

According to the first embodiment, event information is information stored as a single unit, such as identification information automatically assigned based on the date, or an event name specified by a user such as “vacation”, or “sports festival”. Each of the pieces of event information are associated with one or more image ID. The event information can be assigned to each image automatically or input by a user. However, because the first embodiment will be explained on the basis that the event information has already been assigned, the details for the method of assigning the event information for the first embodiment will be omitted.

Moreover, the exposure date and time and the event information are examples of information specifying a group to which each image belongs. For example, As shown in FIG. 2, image IDs 1 through 5 are grouped together by the event name “2008 ski trip”.

Moreover, as shown in FIG. 3, one or more subject information data sets indicating a subject name and where in the image the subject is positioned are associated with each image ID.

While the subject information is expressed in terms of X coordinate (X in the figure), Y coordinate (Y in the figure), and height (H in the figure) values, the subject information according to the present information is not limited to these expressions.

Additionally, while face recognition technology and object recognition technology can be used for setting the subject information, the details regarding the use of these technologies will be omitted. Moreover, a subject name is a name specifying an individual. Subject names can be set automatically, for instance, using face recognition technology or object recognition technology, or by a user entering a subject name at will. However, the first embodiment will be explained on the basis that subject names have already been set for each piece of subject information, and the details of the setting method will be omitted.

Moreover, instead of a name, an ID may be used for the information specifying a subject to identify a person. Furthermore, as information specifying a subject, information specifying an object other than a person may be included in place of or in addition to information specifying a person.

It is to be noted that information is not provided for image ID 4 in FIG. 3 because the image does not contain a person.

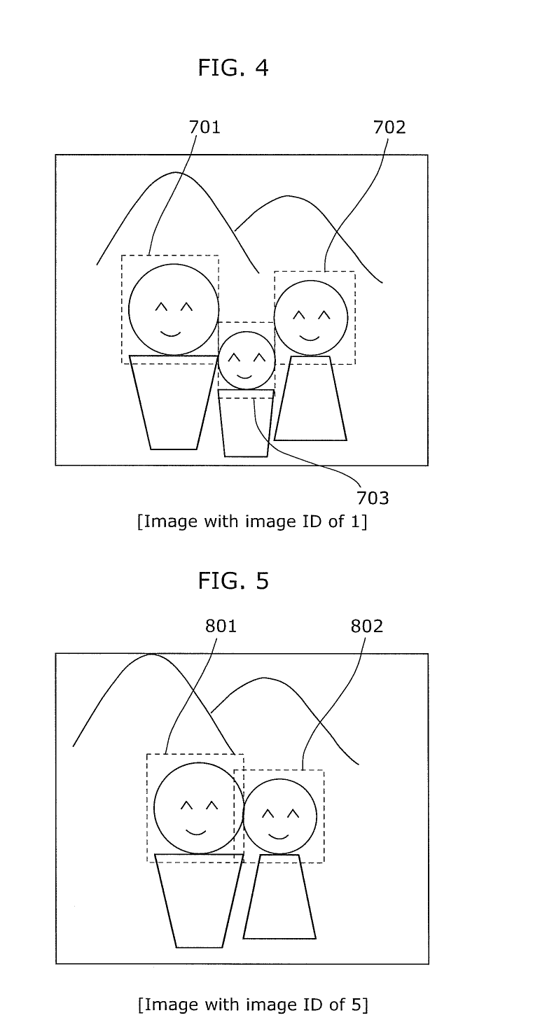

FIG. 4 and FIG. 5 are examples of images. It is to be noted that the rectangles outlined by a dashed line are shown simply for explanation purposes and are not a part of the image.

FIG. 4 shows an image having an image ID of 1. The region enclosed by a dashed line rectangle 701 corresponds with a record 601 shown in FIG. 3, and the subject name shows that the person photographed in the region is “Father”. Moreover, the region enclosed by a dashed line rectangle 702 corresponds with a record 602 in FIG. 3, and the subject name shows that the person photographed in the region is “Mother”. Furthermore, the region enclosed by a dashed line rectangle 703 corresponds with a record 603 in FIG. 3, and the subject name shows that the person photographed in the region is “Taro”.

FIG. 5 shows an image having an image ID of 5. The region enclosed by a dashed line rectangle 801 corresponds with a record 604 shown in FIG. 3, and the subject name shows that the person photographed in the region is “Father”. Moreover, the region enclosed by a dashed line rectangle 802 corresponds with a record 605 in FIG. 3, and the subject name shows that the person photographed in the region is “Mother”.

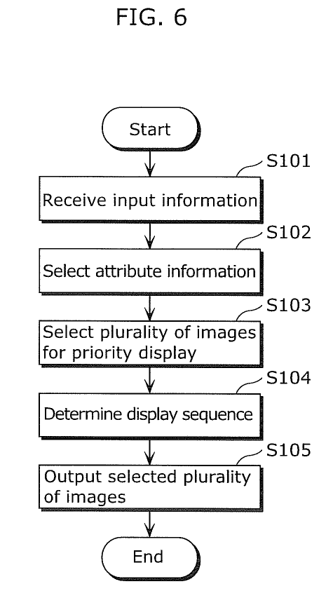

Operation of the image display device 101 configured as described will be explained with an emphasis on the operation of the image output device 100 while referring to FIG. 6 through FIG. 9.

FIG. 6 is a flowchart showing a basic operation of the image output device 100 according to the first embodiment. First, the basic operation of the image output device 100 will be explained while referring to FIG. 6.

The receiving unit 104 receives input information transmitted from the display device 110 (S101).

The attribute information selecting unit 103 selects a single piece of attribute information corresponding to the position information included in the input information from a plurality of pieces of attribute information associated with the display image and notifies the image selecting unit 106 of the selection as a piece of selected attribute information (S102).

The image selecting unit 106 selects, from among the plurality of images stored in the storage device 102, a plurality of images having attribute information corresponding to the selected attribute information (S103).

It is to be noted that when, from among the plurality of images stored in the storage device 102, only a single image has attribute information corresponding to the selected attribute information, the image selecting unit 106 only selects that image.

The display sequence determining unit 107 determines, based on the attribute information of each of the plurality of images, a display sequence of the plurality of selected images, and notifies the output unit 108 of the sequence as a priority display sequence (S104).

The output unit 108 obtains, from the storage device 102, the plurality of selected images, and outputs the plurality of images such that the plurality of images are displayed on the display device 110 in the determined priority display sequence (S105).

As a result of the image output device 100 in the image display device 101 according to the first embodiment conducting the preceding operations, an efficient image selection process whereby the images are selected as intended by a user is executed.

It is to be noted that the basic operations shown in FIG. 6 can also be conducted by the image output device 100 according to each of the second through fifth embodiments to be described later.

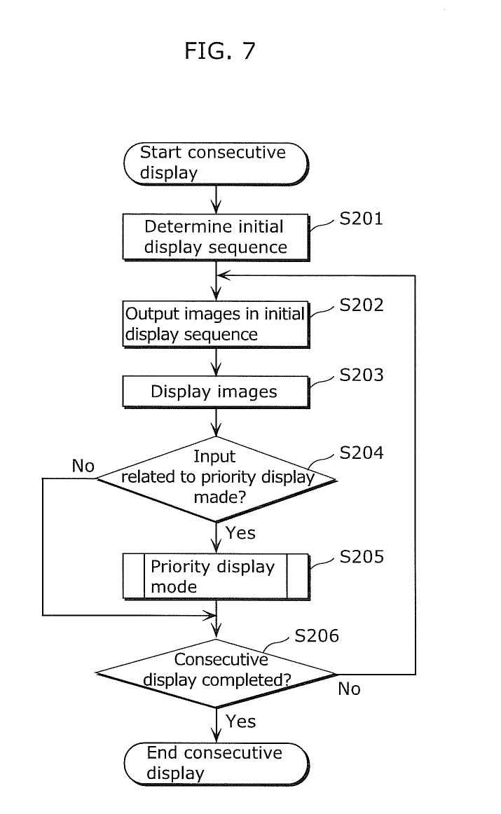

Next, the operation by the image display device 101 at the time the consecutive display process is executed by the image display device 101 will be explained while referring to FIG. 7. The consecutive display process is the process of displaying images sequentially.

FIG. 7 is a flowchart showing an example of an operation performed by the image display device 101 according to the first embodiment.

The display sequence determining unit 107 first determines an initial display sequence and notifies the output unit 108 (S201).

Next, in accordance with the initial display sequence, the output unit 108 reads a single image from the storage device 102 and transmits the image to the display device 110 (S202).

The display device 110 displays the received image on the touch panel display 105 (S203).

Next, the input information acquisition unit 105b determines whether or not any input related to priority display has been made by detecting whether or not a user has made any inputs such as touching the image displayed on the touch panel display 105 (S204).

When an input related to priority display has been made in step S204 (yes in S204), the image display device 101 enters a priority display mode (S205). The priority display mode will be explained later. Step S206 is performed when the priority display mode (S205) is completed.

When no input related to priority display has been made in step S204 (no in S204), the output unit 108, for example, determines the consecutive display of images to be complete. When a given condition for completion, such as a condition regarding the number of images that have been displayed, is satisfied (yes in S206), the consecutive display of images is ended. If the given condition for completion is not satisfied (no in S206), the process returns to step S202.

### [Determination of the Initial Display Sequence]

The initial display sequence is determined for all of the images stored in the storage device 102 by the display sequence determining unit 107 by, for example, the following methods. The methods of determining the initial display sequence are, however, not limited to these examples. Other methods or a combination of methods may be also be used.

(1) The initial display sequence is arranged according to the exposure date and time of each of the images. In this case, the images may be displayed in ascending or descending order.

(2) The initial display sequence is arranged according to the image ID of each of the images. In this case, the images may be displayed in ascending or descending order.

(3) All images are randomly arranged in the initial display sequence. In this case, the display sequence determining unit 107 determines the display sequence of each of the images by randomizing, for example, the image ID attribute information of each of the images. The same process is executed for a plurality of images when the plurality images are randomly arranged for the display sequence.

(4) The initial display sequence is determined by sequentially selecting from among all images those with an exposure date and time closest to the current time of day.

(5) The initial display sequence is determined by sequentially selecting from among all images those with an exposure date and time closest to the current date.

### [Determination of the Completion of Consecutive Display]

The completion of the consecutive display of images is determined by the following methods. The methods of determining the end of consecutive display are, however, not limited to these examples. Other methods may be also be used.

(1) The consecutive display of images is ended when a given amount of time passes from the beginning of the consecutive display of images.

(2) The consecutive display of images is ended when a given number of images are displayed from the beginning of the consecutive display of images.

(3) The consecutive display of images is ended when a user selects an icon or text displayed along with the images on the touch panel display 105 to end the display of images.

(4) The consecutive display of images is ended when a user instructs the end of the display by a means provided by the image display device 101, such as a button not shown in the drawings.

### [Priority Display Mode]

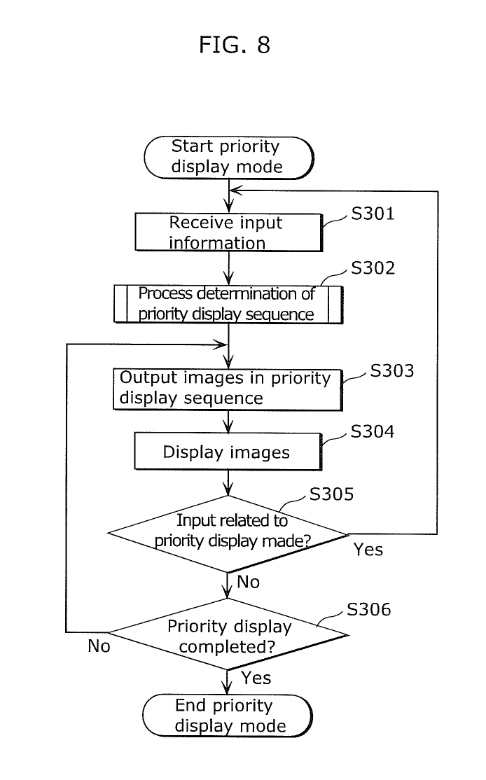

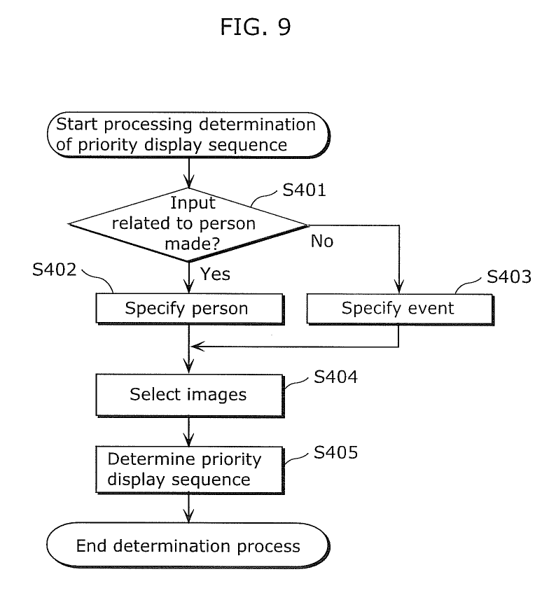

Operation of the display device 101 while in priority display mode will be explained while referring to the flowcharts in FIG. 8 and FIG. 9.

It is to be noted that steps S401 through S405 of FIG. 9 are condensed and stated as “process determination of priority display sequence (S302)”.

When an input related to priority display has been made, in other words, when the receiving unit 104 receives input information, the receiving unit 104 transmits, at the very least, the position information indicating a position on the display image which is included in the input information to the attribute information selecting unit 103 (S301).

The priority display sequence is determined based on the position information transmitted to the attribute information selecting unit 103 (S302). Specifically, the processes in steps S401 through S405 shown in FIG. 9 are executed.

The attribute information selecting unit 103 compares the position information indicating a position on the display image included in the received input information with a subject position associated with the display image. When, according to the result of the comparison, the position indicated by the position information is within the region of the subject position (yes in S401), step S402 is performed. When the position indicated by the position information is outside the region of the subject position (no in S401), step S403 is performed (S401).

The attribute information selecting unit 103 determines that the subject name corresponding to the subject position has been selected and transmits the subject name to the image selecting unit 106 when the position indicated by the position information is within the region of the subject position. In other words, the attribute information selecting unit 103 selects the subject name as the selected attribute information corresponding to the position information included in the input information from a plurality of pieces of attribute information associated with the display image.

For example, when the display image is the image with the image ID of 1 (see FIG. 4) and the position indicated by the position information is within the region of the subject position of the record 601 (the dashed line rectangle 701 in FIG. 4), the attribute information selecting unit 103 selects and transmits the subject name “Father” to the image selecting unit 106 (S402).

When the position indicated by the position information is outside the region of the subject position, the attribute information selecting unit 103 obtains the information specifying the group to which the display image belongs. Specifically, the attribute information selecting unit 103 obtains event information associated with the display image and transmits that event information to the image selecting unit 106 as a piece of selected attribute information.

For example, assume that the display image is the image with the image ID of 1, and the attribute information selecting unit 103 assumes the position indicated by the position information is outside any of the regions of the subject positions of the records the 601, 602, or 603. In this case, the attribute information selecting unit 103 will, for example, obtain and transmit the event information “2008 ski trip” of a record 501 in FIG. 2 to the image selecting unit 106 (S403).

The image selecting unit 106 obtains a list of image IDs of images having a received subject name or event information as attribute information, and transmits at the very least the list of image IDs to the display sequence determining unit 107.

For example, when the subject name “Father” is received, the image selecting unit 106 obtains and transmits a list of the image IDs of images associated with the subject name “Father”, such as image IDs 1, 3, 5, and 103 (see FIG. 3) (S404).

Moreover, when the event information “2008 ski trip” is received, the image selecting unit 106 obtains and transmits a list of image IDs of images associated with the event information “2008 ski trip”, such as image IDs 1, 2, 3, 4, and 5 (see FIG. 2) (S404).

The display sequence determining unit 107 determines a priority display sequence by a given method on the basis of the received list of image IDs, and transmits at the very least the priority display sequence to the output unit 108 (S405).

Afterwards, step S303 shown in FIG. 8 is executed. Specifically, the output unit 108 reads and outputs the corresponding images according to the order indicated by the received priority display sequence from the storage device 102 to the display device 110 (S303).

The display device 110 displays the received images on the touch panel display 105 (S304).

Next, the input information acquisition unit 105b determines whether or not any input related to priority display has been made by detecting whether or not a user has made any inputs, such as touching the image displayed on the touch panel display 105 (S305).

When an input related to priority display has been made in step S305 (yes in S305), the process returns to step S301. In other words, according to this embodiment, when a subsequent input is made while operating in priority display mode due to a prior input, images are reselected based on the subsequent input.

When no input related to priority display has been made in step S305 (no in S305), a process for determining the completion of the priority display mode is executed. When a given condition for completion, such as a condition regarding the number of images that have been displayed, is satisfied (yes in S306), the priority display mode is ended. If the given condition for completion is not satisfied (no in S303), the process returns to step S303.

### [Methods of Determining the Priority Display Sequence]

The priority display sequence of a plurality of images selected by the image selecting unit 106 is determined in step S405 by, for example, the following methods. The methods of determining the priority display sequence are, however, not limited to these examples. Other methods or a combination of methods may be also be used.

(1) The priority display sequence is arranged according to the exposure date and time of the plurality of images. In this case, the images may be displayed in ascending or descending order.

(2) The priority display sequence is arranged according to the image ID of a plurality of images. In this case, the images may be displayed in ascending or descending order.

(3) The priority display sequence of a plurality of images is randomly arranged.

### [Determination of the Completion of Priority Display Mode]

The completion of the priority display mode in step S306 is determined by the following methods. The methods of determining the end of consecutive display are, however, not limited to these examples. Other methods may be also be used.

(1) The priority display mode is ended when the sequence determined to be the priority display sequence is displayed one or more times than a given number.

(2) The priority display mode is ended when a given amount of time has elapsed from the start of the priority display mode.

(3) The priority display mode is ended when a given number of images have been displayed from the start of the priority display mode.

(4) The priority display mode is ended when a user selects an icon or text displayed along with the images on the touch panel display 105 to end the priority display mode.

(5) The priority display mode is ended when a user instructs the end of the priority display mode by a means provided by the image display device 101, such as a button not shown in the drawings.

(6) The priority display mode is ended when a user performs a given action on the touch panel display 105. A user making a swipe gesture on touch panel display with his or her finger, for example, can be considered a given action. However, it is to be noted that a given action is not limited to this example.

With the image display device 101 according to the first embodiment as described, the image output device 100 determines a piece of selected attribute information from input information obtained by a simple operation such as a user touching the display image in a specified location. The image output device 100 further selects images for priority display based on the selected attribute information. This allows for efficient selection and the consecutive display of a plurality of images that meet a given condition.

It is to be noted that in the first embodiment the subject information is expressed as a set of an X coordinate, a Y coordinate, and height corresponding to a dashed line rectangle. However, the subject information can be expressed, for example, as coordinates and radii representing other shapes such as circles or ellipses, as coordinates of vertexes or as central coordinates and vectors to vertexes from central coordinates representing, for example, polygons, or as vectors from a base point. Any method can be used to express the subject information as long as the method represents a specified region on the image.

For example, by expressing where a subject is located as a polygon, subject information can be determined based on a more detailed border line. It is to be noted that units of pixels or units of length such as millimeters may be used for the coordinates.

Moreover, in FIG. 4 and FIG. 5, the regions associated with subjects, the subjects being people in this case, are centered on the faces of the subjects. However, regions encompassing the entire subject, or regions centered on areas other than faces are acceptable. In other words, a region is acceptable as long as a subject and the region associated with the subject are bound adhering to a predetermined rule.

Moreover, the storage device 102 does not need to be built into the image display device 101, and may be connected to the image output device 100.

The storage device 102 may, for example, be set up outside the image display device 101. In this case the storage device 102 can be connected to the image output device 100 by various interfaces including wired and wireless interfaces. Moreover, the storage device 102 may be connected to the image output device 100 over a network such as the internet. The image output device 100 is also capable of connecting to a plurality of the storage device 102. This allows for a flexible system configuration.

Moreover, in the first embodiment, a person was used as a piece of attribute information indicating a subject, but when the subject is a different physical object, such as an animal or an object, an animal name or a name for the object can be used. When this is the case, a user can touch not just a person, but a physical object, causing images containing that physical object to be selected and displayed for priority display.

Names for physical objects can be automatically assigned by object recognition or can be input by a user. However, the details regarding the assigning of names will be omitted from the first embodiment.

Moreover, it goes without saying that the output unit 108 or the display control unit 109 is capable of controlling the display time for each image (in other words, the time interval between the display of each image), but the display time for each image may be altered individually for the initial display sequence and the priority display sequence. Moreover, when the number of images to be consecutively displayed is a given number or less, a longer display time for each image can be set.

Moreover, the display control unit 109 can control the transition effect when the display transitions from one image to the next. Furthermore, the transition effect may be altered individually for the initial display sequence and the priority display sequence

Moreover, the display control unit 109 may display on the touch panel display 105 information indicating whether or not the image currently being displayed is being displayed in the priority display mode.

Moreover, the processing sequences according to the first embodiment shown in the flowcharts (FIG. 6 through FIG. 9) are not limited to the sequences shown in the flowcharts in particular, and it goes without saying that the sequence of the steps may be rearranged as long as the same end result is achieved.

### Second Embodiment

The functional configuration of the image display device 101 according to the second embodiment is the same as that of the image display device 101 according to the first embodiment shown in FIG. 1, and the basic processes for each respective component is the same as that of the image display device 101 according to the first embodiment. Therefore, these descriptions will be omitted.

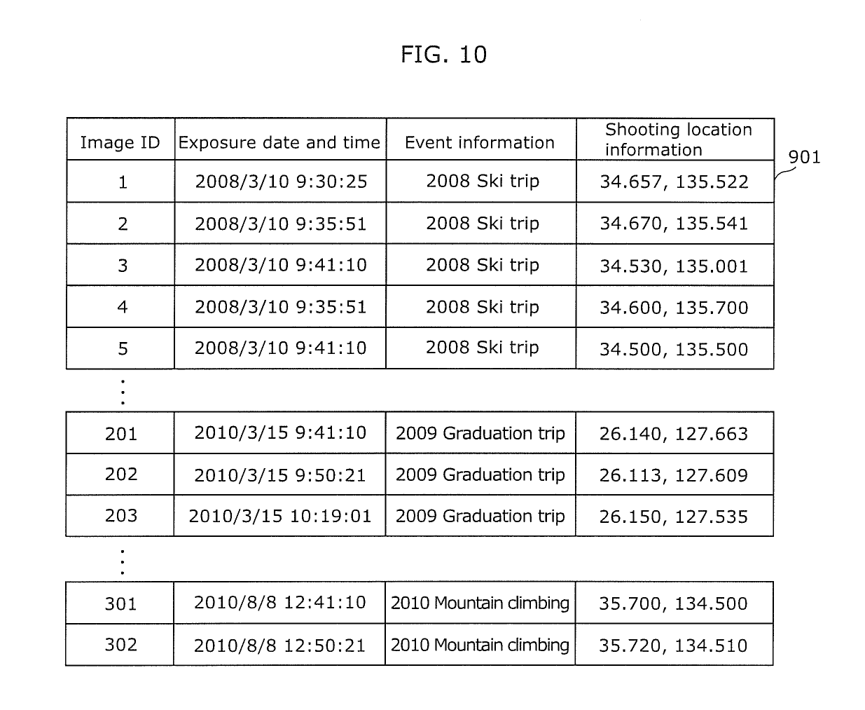

FIG. 10 is an example of a data structure showing images and their respective attribute information stored in the storage device 102 according to the second embodiment of the present invention.

As shown in FIG. 10, an image ID for identifying each image and the exposure date and time, the event information, and the shooting location information, which are attribute information associated with the images, are stored in the storage device 102 according to the second embodiment.

It is to be noted event information is information stored as a single unit, such as identification information automatically assigned based on the date, or an event name specified by a user such as “vacation”, or “sports festival”. Each of the pieces of event information are associated with one or more image ID. The event information can be assigned to each image automatically or input by a user. However, because the second embodiment will be explained on the basis that the event information has already been assigned, the details for the method of assigning the event information for the second embodiment will be omitted.

Moreover, the shooting location information according to the second embodiment is, for example, GPS (Global Positioning System) information, and is information specifying a group to which each image belongs. Shooting location information can be recorded automatically by the camera or a GPS recording device automatically, or input by a user. However, because the second embodiment will be explained on the basis that the shooting location information has already been assigned, the details for the method of assigning the shooting location information for the second embodiment will be omitted.

Moreover, while the shooting location information in FIG. 10 is displayed as longitude and latitude coordinates in decimal notation, it goes without saying that a more precise method of notation such as degree-minute-second notation is also acceptable. Moreover, the shooting location information can be displayed as text, such as a place name.

The second embodiment will be explained while referring to FIG. 4 as an example of an image handled by the image display device 101, and to the data structure shown in FIG. 3 as a data structure where the subject position and subject name are associated.

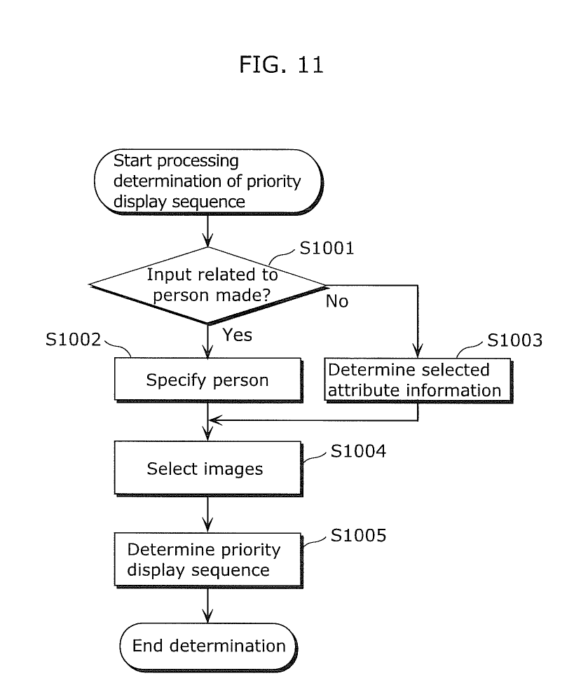

Operation of the image display device 101 according to the second embodiment configured as described will be explained while referring to the flowchart shown in FIG. 11.

The flowchart shown in FIG. 11 is associated with the flowchart according to the first embodiment shown in FIG. 9, and contains the processes condensed within the step “process determination of priority display sequence (S302)” shown in FIG. 8.

Because other principle operations of the image display device 101 according to the second embodiment are the same as those in FIG. 7 and FIG. 8, those operations are referenced under the first embodiment. Only the processes executed by the image display device 101 according to the second embodiment shown in FIG. 11 will be explained.

The attribute information selecting unit 103 compares the position information indicating a position on the display image included in the received input information with a subject position associated with the display image. When, according to the result of the comparison, the position indicated by the position information is within the region of the subject position (yes in S1001), step S1002 is performed. When the position indicated by the position information is outside the region of the subject position (no in S1001), step S1003 is performed.

When the position indicated by the position information is within the region of the subject position, the attribute information selecting unit 103 determines that the subject name corresponding to the subject position has been selected and transmits the subject name to the image selecting unit 106.

For example, when the image being displayed is the image with the image ID of 1 and the input position information is within the region of the subject position of the record 601, the attribute information selecting unit 103 selects and transmits the subject name “Father” to the image selecting unit 106 (S1002).

When the position indicated by the position information is outside the region of the subject position, the attribute information selecting unit 103 determines, by a given method, a piece of attribute information associated with the image being displayed to be the selected attribute information, and transmits the selected attribute information to the image selecting unit 106, the attribute information being either the event information, the exposure date and time, or the shooting location information.

For example, when the image being displayed is the image with the image ID of 1 and the position indicated by the position information is outside any of the regions of the subject positions of the records 601, 602, or 603, the selected attribute information is determined from a record 901 shown in FIG. 10 (S1003). Methods of determining the selected attribute information which is a piece of attribute information other than a subject name will be described later.

The image selecting unit 106 obtains a list of image IDs of images having the selected attribute information as a received subject name or a piece of attribute information other than a subject name, and transmits at the very least the list of image IDs to the display sequence determining unit 107.

For example, when the subject name “Father” is received, the image selecting unit 106 obtains and transmits a list of image IDs of the images associated with the subject name “Father”, such as image IDs 1, 3, 5, and 103. Moreover, when the selected attribute information that is a piece of attribute information other than a subject name is received, the image selecting unit 106 obtains and transmits a list of image IDs by a given method. Methods of obtaining a list of image IDs corresponding to a piece of selected attribute information other than a subject name will be described later.

The display sequence determining unit 107 determines a priority display sequence by a given method on the basis of the received list of image IDs, and transmits at the very least the priority display sequence to the output unit 108 (S1005).

[Methods of Determining a Piece of Attribute Information Other than a Subject Name to be the Selected Attribute Information]

A piece of attribute information other than a subject name is determined to be the selected attribute information in step S1003 by, for example, the following methods. The methods of determining the selected attribute information are, however, not limited to these examples. Other methods or a combination of methods may be also be used.

(1) A priority sequence order is assigned in advance for each of the pieces of attribute information and the selected attribute information is determined based on that order.

(2) The attribute information associated with the action information included in the input information is determined to be the selected attribute information.

For example, when the action information indicates a single tap, the exposure date and time is selected; when the action information indicates a double tap, the event information is selected; and when the action information indicates a long press (when a user touches the touch panel longer than a given time), the shooting location information is selected.

It is to be noted that these types of actions indicated by the action information are examples. Information indicating other types of actions may be included in the action information and may be used to determine the selected attribute information. Moreover, the paring of the action information with a piece of attribute information is not limited to the combinations previously exemplified. The combinations may be switched.

(3) When something other than a person is selected, a user is prompted by a display on the touch panel display 105 to select a piece of attribute information, and the selected attribute information is determined based on the selection of the user.

(4) When something other than a person is selected, some piece of attribute information is determined to be the selected attribute information, whereupon the determined selected attribute information is displayed on the touch panel display 105. Subsequently, when a user further selects something other than a person, some piece of attribute information other than the previously selected selected attribute information replaces the displayed selected attribute information. This enables the selected attribute information and sequence to be changed by user operation.

(5) The selected attribute information is determined by giving priority to a piece of attribute information often selected by a user.

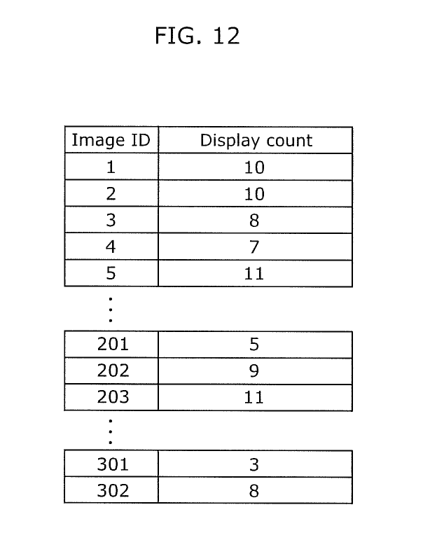

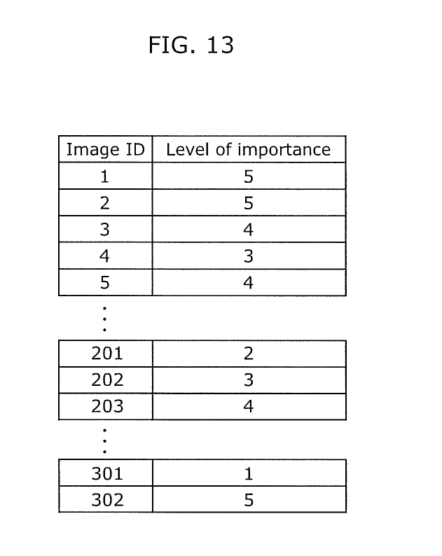

It is to be noted that attribute information other than a subject name is not limited to exposure date and time, event information, and shooting location information shown in FIG. 10, but may be display count as is shown in FIG. 12, or level of importance as is shown in FIG. 13.

Display count is managed, for example, by storing the number of times an image has been displayed in the storage device 102, as is shown in FIG. 12, and by increasing the display count of a displayed image by one each time the image display is controlled by an image being output to the display device 110 by the output unit 108.

Level of importance is managed, for example, by storing a level of importance for each of the images in the storage device 102, as is shown in FIG. 13, and by a user setting a level of importance for each image via the receiving unit 104. It is to be noted that a means for receiving a level of importance input by a user other than the receiving unit 104 may be used.

[Methods of Obtaining a List of Image IDs from the Selected Attribute Information that is a Piece of Attribute Information Other than a Subject Name]

A list of image IDs is obtained from the selected attribute information that is a piece of attribute information other than a subject name in step S1004 by, for example, the following methods. The methods of obtaining the list are, however, not limited to these examples. Other methods or a combination of methods may be also be used.

(1) When the selected attribute information is a piece of event information, the image IDs of images having the same event information are obtained.

(2) When the selected attribute information is a piece of exposure date and time attribute information, the image IDs of images having an exposure date and time that is within a given period of time from the exposure date and time of the selected attribute information are obtained.

(3) When the selected attribute information is a piece of exposure date and time attribute information, the image IDs of images having an exposure date and time that is the same month or a month within a given span of the exposure date and time of the selected attribute information are obtained. For example, in the record 901, when the selected attribute information is determined to be the exposure date and time attribute information, the image selecting unit 106 will obtain the image IDs 1, 2, 3, 4, 5, 201, 202, and 203.

(4) When the selected attribute information is a piece of exposure date and time attribute information, the image IDs of images having an exposure date and time that is the same season as the exposure date and time of the selected attribute information are obtained.

(5) When the selected attribute information is a piece of exposure date and time attribute information, the image IDs of images having an exposure date and time that is within the same decade of the exposure date and time of the selected attribute information are obtained.

(6) When the selected attribute information is a piece of shooting location information, the image IDs of images having a shooting location information that is within a given range of the shooting location information of the selected attribute information are obtained. For example, in the record 901, when the selected attribute information is determined to be the shooting location information, the image selecting unit 106 will obtain the image IDs 1, 2, 3, 4, 5, 301, and 302.

(7) When the selected attribute information is a piece of display count attribute information, the image IDs of images having a display count that is the same as or higher, or a display count that is the same as or lower than a given display count will be obtained.

(8) When the selected attribute information is display count, the image IDs of images having a display count that is the same as or higher, or a display count that is the same as or lower than that of the image on which a position has been specified will be obtained.

(9) When the selected attribute information is a piece of display count information, the image IDs of images having a same display count, or a display count that is within a given range of that of the image on which a position has been specified will be obtained.

(10) When the selected attribute information is a piece of level of importance attribute information, the image IDs of images with a level of importance that is a given value or higher, or a level of importance that is a given value or lower will be obtained.

(11) When the selected attribute information is a piece of level of importance attribute information, the image IDs of images with a level of importance that is higher, or a level of importance that is lower than that of the image on which a position has been specified will be obtained.

(12) When the selected attribute information that is a piece of level of importance attribute information, the image IDs of images having a same level of importance, or a level of importance that is within a given range of that of the image on which a position has been specified will be obtained.

It is to be noted that given ranges used in methods (6), (9), and (12) above may be individually assigned in advance or specified otherwise by a user.

### [Methods of Determining the Priority Display Sequence]

The priority display sequence of a plurality of images selected by the image selecting unit 106 is determined in step S1005 by, for example, the following methods. The methods of determining the priority display sequence are, however, not limited to these examples. Other methods or a combination of methods may be also be used.

(1) The priority display sequence is arranged according to the exposure date and time of the plurality of images. In this case, the images may be displayed in ascending or descending order.

(2) The priority display sequence is arranged according to the image ID of a plurality of images. In this case, the images may be displayed in ascending or descending order.

(3) The priority display sequence of a plurality of images is randomly arranged.

(4) A given number of images or less are selected from among a plurality of images and designated as a set. The priority display sequence of the set is determined using one of the methods (1) through (3). According to the second embodiment, the set includes one or more images.

(5) A set differing from the set designated in method (4) is designated. The priority display sequence is determined by displaying the different set after the set designated in method (4) is displayed.

(6) A set is determined by selecting a given number of images or less that were taken in the same decade based on the exposure date and time associated with each of the plurality of images.

For example, images taken during a given decade are selected from the plurality of images and split into groups of 10 images or less, each group being designated as a set. This process of selection is also repeated for each decade. Furthermore, the priority display sequence is determined such that each set is displayed in ascending or descending order.

(7) The priority display sequence is arranged according to the display count of a plurality of images. In this case, the images may be displayed in ascending or descending order.

(8) The priority display sequence is arranged according to the level of importance of a plurality of images. In this case, the images may be displayed in ascending or descending order.

(9) An ascending or descending order is determined according to the action information included in the input information.

(10) The method of determining the priority display sequence is determined according to the action information included in the input information.

It is to be noted that while the designation of a set took place in step S1005, a set may be designated in advance in step S1004.

Moreover, the number of images to be included in a set can be, for example, stipulated in advance, set by a user, or set as being within a given amount of time being the total time it takes to display all the images of a set.

The given amount of time can be, for example, stipulated in advance, set by a user, or set to match the length of the Background Music (BGM) playing along with the display as well. While details regarding methods of playing BGM will be omitted, it goes without saying that any general method of playing BGM can be accomplished if speakers and a means of reproducing the BGM are available.

Moreover, the display sequence determining unit 107 may determine a priority display sequence based on the attribute information corresponding to the selected attribute information of each of the images.

For example, assume that shooting location information has been determined to be the selected attribute information. In this case, the display sequence determining unit 107 may refer to the shooting location information of each of the plurality of images selected by the image selecting unit 106 (see FIG. 10) to determine a priority display sequence such that the plurality of images are displayed, for example, according to longitude in descending or ascending order, or according to latitude in descending or ascending order.

For example, assume that exposure date and time has been determined to be the selected attribute information. In this case, the display sequence determining unit 107 refers to the exposure date and time of each of the plurality of images selected by the image selecting unit 106 (see FIG. 10) and determines a priority display sequence such that the plurality of images are displayed, for example, in chronological order or reverse chronological order.

With the image display device 101 according to the second embodiment as described, the image output device 100 determines the selected attribute information from input information obtained by a simple operation such as a user touching the display image in a specified location. The image output device 100 further selects images with display priority based on the selected attribute information. This allows for efficient selection and the consecutive display of a plurality of images that meet a given condition.

Moreover, because a priority display sequence can be determined and image IDs can be obtained according to display count or level of importance, images which a user most wishes to see can be selected and displayed efficiently.

Moreover, the processing sequences according to the second embodiment shown in the flowchart (see FIG. 11) are not limited to the sequences shown in the flowchart in particular, and it goes without saying that the sequence of the steps may be rearranged as long as the same end result is achieved.

Moreover, an image does not need to have all of the attribute information exemplified in the second embodiment; it is sufficient for an image to have at least one piece of attribute information. Moreover, attribute information is not limited to the attribute information described in the second embodiment. Attribute information other than these can be used for determining a display sequence or selecting images in the image output device 100.

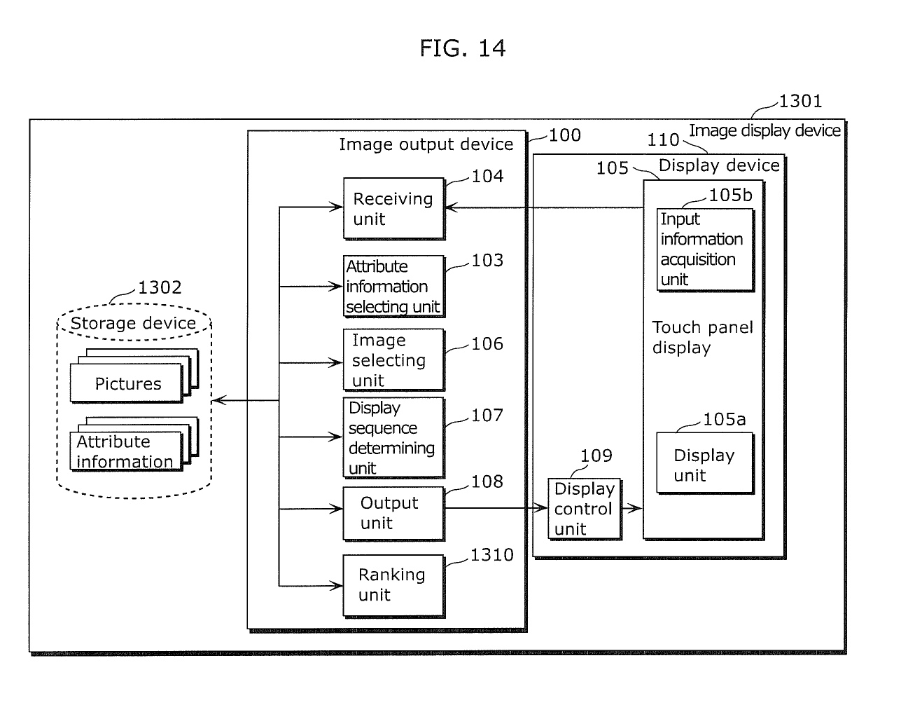

Moreover, while level of importance is shown as having five levels in FIG. 14, level of importance is not limited to this example. Other evaluation values can be assigned for level of importance, as in any event, the same effect will be achieved.

### Third Embodiment

FIG. 14 is a block diagram showing the main part of the configuration of an image display device 1301 according to the third embodiment of the present invention.

The image display device 1301 is characteristic in that it includes a storage device 1302 in place of the storage device 102, and a ranking unit 1310 is included in the image output device 100. All other components are the same as those in the image display device 101 according to the first embodiment shown in FIG. 1 and each component is assigned with the same number as in the first embodiment, thus explanation thereof will be omitted.

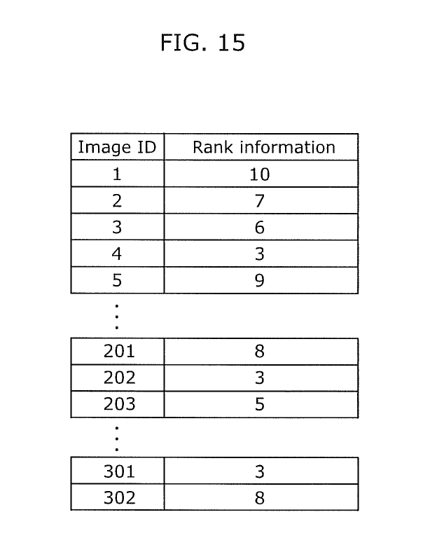

The storage device 1302 stores, in addition to the various types of information shown in FIG. 2, FIG. 3, and FIG. 10, rank information for each of the images such as is shown in FIG. 15.

The ranking unit 1310 determines rank information depicting a rank of each image based on the people captured in each image. Rank information is an example of information specifying a group to which each group belongs, and is information which recognizes and assigns a value to images which are deemed to be important to a user. Moreover, rank information is determined, for example, by the following methods. The methods of determining the rank information, however, not limited to these examples. Other methods or a combination of methods may be also be used.

Moreover, according to the third embodiment, rank information of anywhere from one to ten is associated with every image.

(1) Upon inspection of all images, rank information is increased for images containing a person who appears in images frequently.

(2) Rank information is increased for images which contain a person who frequently appears together with a person who appears in images frequently.

(3) Rank information is increased for all images which contain a person who appears in an image selected by a user.

(4) Rank information is increased for all images which contain a person selected by a user.

Operations of the image display device 1301 configured as described will be explained. The basic process flow is the same as the process flow shown in the flowcharts according to the first and second embodiments. For that reason, the methods in the third embodiment which differ from the processes in the first and second embodiment, being the methods of determining a piece of attribute information other than a subject name to be the selected attribute information, the methods of obtaining a list of image IDs from the selected attribute information that is a piece of attribute information other than a subject name, and the methods of determining the priority display sequence, will be explained.

[Methods of Determining a Piece of Attribute Information Other than a Subject Name to be the Selected Attribute Information that is]

In addition to the candidates for the selected attribute information according to the first and second embodiments, a piece of rank information can also be determined to be the selected attribute information.

[Methods of Obtaining a List of Image IDs from the Selected Attribute Information that is a Piece of Attribute Information Other than a Subject Name]

In addition to the methods of obtaining a list of image IDs described in the first and second embodiments, the following methods exist according to the third embodiment. The methods of obtaining a list of image IDs are, however, not limited to these examples. Other methods or a combination of methods may be also be used.

(1) When the selected attribute information is a piece of rank information, the image IDs of images having rank information that is a given value or higher, or rank information that is a given value or lower will be obtained.

(2) When the selected attribute information is a piece of rank information, the image IDs of images having rank information that is the same as or higher, or rank information that is the same as or lower than the rank information of the image on which a position has been specified will be obtained.

(3) When the selected attribute information is a piece of rank information, the image IDs of images having the same rank information, or rank information that is within a given range of the rank information of the image on which a position has been specified will be obtained.

### [Methods of Determining the Priority Display Sequence]

In addition to the methods of determining the priority display sequence described in the first and second embodiments, the following methods exist according to the third embodiment. The methods of determining the priority display sequence are, however, not limited to these examples. Other methods or a combination of methods may be also be used.

(1) The priority display sequence is arranged according to the rank information of a plurality of images selected by the image selecting unit 106. In this case, the images may be displayed in ascending or descending order.

It is to be noted that it is not necessary for rank information to use levels of evaluation values from one to ten. Other evaluation values can be used as well.

According to the third embodiment of the image display device 1301, because the image output device 100 can obtain a list of image IDs from the rank information as well as determine a priority display sequence, images which a user most wishes to see can be selected and displayed efficiently.

It is to be noted that FIG. 14 shows that the ranking unit 1310 is included in the image display device 1301. The ranking unit 1310 may, however, be located outside the image display device 1301 and may access the storage device 1302 to set up the rank information via a connected interface not shown in the drawings. This allows for a flexible system configuration.

### Fourth Embodiment

The functional configuration of the image display device according to the fourth embodiment is the same as that of the image display device 101 and the image display device 1301 according to the first, second, and third embodiments, thus explanation thereof will be omitted.

It is to be noted that in the following explanation it is assumed that the image display device 101 according to the second embodiment is employed as the image display device of the fourth embodiment. Therefore, the characteristic operations of the image display device 101 according to the fourth embodiment will be explained.

The fourth embodiment will be explained while referring to FIG. 4 as an example of an image handled by the image display device 101, and to the data structures shown in FIG. 3 and FIG. 10.

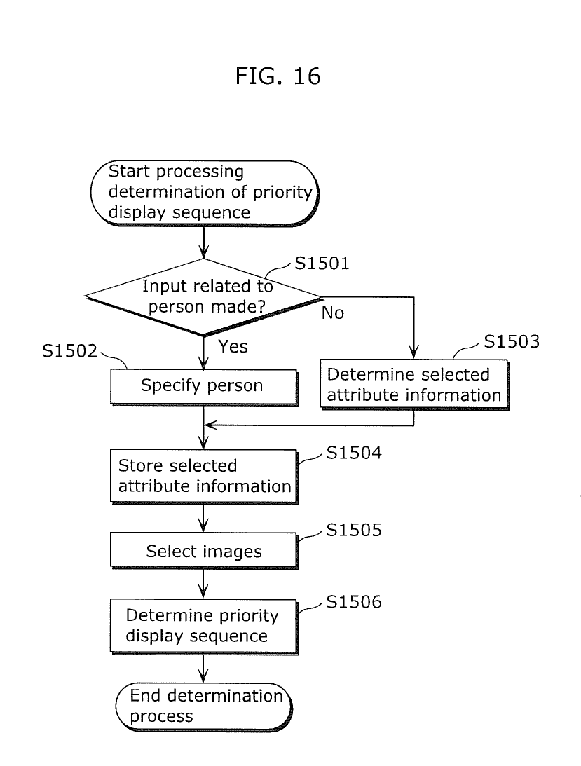

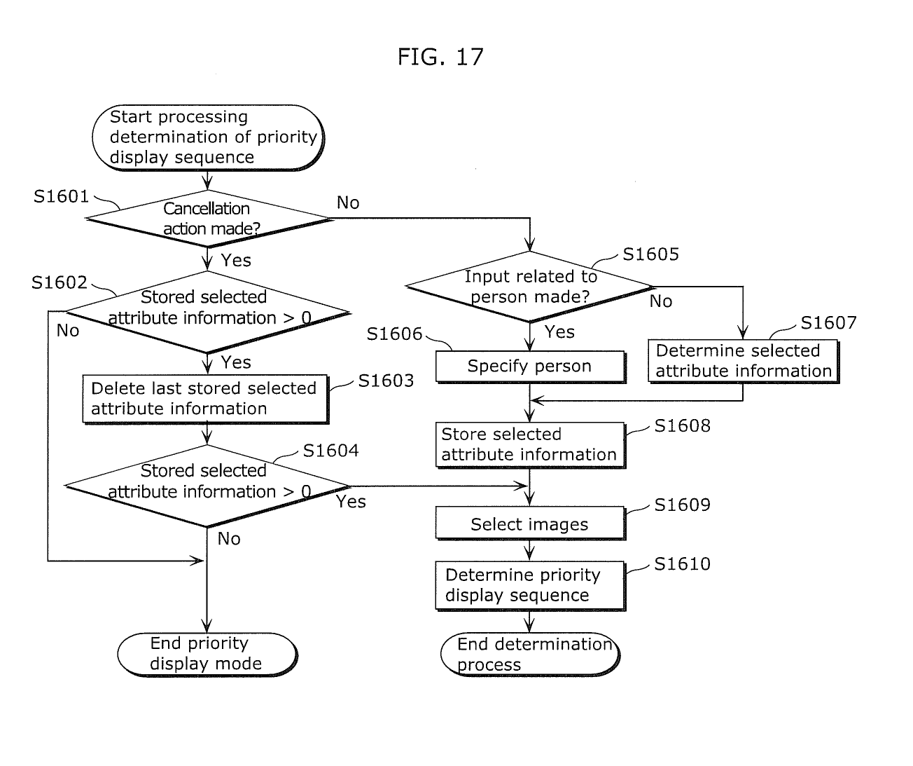

FIG. 16 is a flowchart which contains the processes condensed within the step “process determination of priority display sequence (S302)” shown in FIG. 8. Because other principle operations of the image display device 101 according to the fourth embodiment are the same as those in FIG. 7 and FIG. 8, those operations are referenced under the first embodiment. Only the processes executed by the image display device 101 according to the fourth embodiment shown in FIG. 16 will be explained.

The attribute information selecting unit 103 compares the position information indicating a position on the display image included in the received input information with a subject position associated with the display image. When, according to the result of the comparison, the position indicated by the position information is within the region of the subject position (yes in S1501), step S1502 is performed. When the position indicated by the position information is outside the region of the subject position (no in S1501), step S1503 is performed.

When the position indicated by the position information is within the region of the subject position, the attribute information selecting unit 103 determines that the subject name corresponding to the subject position has been selected and transmits the subject name to the image selecting unit 106.

For example, when the image being displayed is the image with the image ID of 1 and the input position information is within the region of the subject position of the record 601, the subject name “Father” is selected and transmitted to the image selecting unit 106 (S1502).

When the position indicated by the position information is outside the region of the subject position, the attribute information selecting unit 103 determines, by a given method, a piece of attribute information associated with the image being displayed to be the selected attribute information, and transmits the selected attribute information to the image selecting unit 106, the attribute information being either the event information, the exposure date and time, or the shooting location information.

For example, when the image being displayed is the image with the image ID of 1 and the position indicated by the position information is outside any of the regions of the subject positions of the records 601, 602, or 603, the selected attribute information is determined from the record 901 shown in FIG. 10 (S1503). Methods of determining a piece of attribute information other than a subject name to be the selected attribute information are the same as the methods described in the first and second embodiments, thus explanation thereof will be omitted.

The image selecting unit 106 stores the selected attribute information that is a received subject name or a piece of attribute information other than a subject name (S1504). The selected attribute information may be stored in any location to which the image selecting unit 106 has access, including in the storage device 102 or in memory not shown in the drawings.

When one or more previously received pieces of selected attribute information that are subject names or pieces of attribute information other than subject names are stored in the image selecting unit 106, the image selecting unit 106 obtains a list of image IDs of images associated with a newly received piece of selected attribute information and associated with all of the one or more stored selected pieces of attribute information, and transmits at the very least the list of image IDs to the display sequence determining unit 107.

It is to be noted that a piece of selected attribute information previously received and stored by the image selecting unit 106 is an example of the first attribute information in regard to the image output device according to an aspect of the present invention, and the piece of selected attribute information newly received by the image selecting unit 106 is an example of the second attribute information in regard to the image output device according to an aspect of the present invention.

For example, when the subject name “Father” is received, the image selecting unit 106 obtains and transmits to the display sequence determining unit 107 a list of image IDs of the images associated with the subject name “Father”, such as image IDs 1, 3, 5, and 103.

Assume that the image selecting unit 106 receives, as a piece of selected attribute information, the event information “2008 ski trip” while the image selecting unit 106 is storing the subject name “Father” as a piece of selected attribute information. In this case, the image selecting unit 106 obtains and transfers a list of image IDs of images having both the subject name and the event information (“Father” and “2008 ski trip”), such as image IDs 1, 3, and 5, to the display sequence determining unit 107 (S1505).

The display sequence determining unit 107 determines a priority display sequence by a given method on the basis of the received list of image IDs, and transmits at the very least the priority display sequence to the output unit 108 (S1506). The methods of determining the priority display sequence described in the first, second, and third embodiments may be used, thus explanation thereof will be omitted.

It is to be noted that a piece of attribute information that is a subject name as well as a piece of attribute information other than a subject name stored in the image display device 101 are discarded upon completion of the priority display mode.

Moreover, the following additional examples for the step S105 are conceivable, but are not limited thereby.

### [Processes for Selecting Images (S1505)]

(1) When one or more previously received pieces of selected attribute information are stored, the image selecting unit 106 obtains a list A of image IDs of images associated with a newly received piece of selected attribute information and associated with all of the one or more stored pieces of selected attribute information.

When the number of image IDs in the list A of image IDs is a given number or less, the image selecting unit 106 further obtains a list B of image IDs of images selected solely on the condition of the newly received selected attribute information. In other words, the image selecting unit 106 selects a plurality of images each having a piece of attribute information corresponding to the newly received selected attribute information, regardless of whether the plurality of images have a piece of attribute information corresponding to the previously received selected attribute information or not. The image selecting unit 106 transmits at the very least the list B of image IDs to the display sequence determining unit 107.

(2) When one or more previously received pieces of selected attribute information are stored, the image selecting unit 106 obtains a list A of image IDs of images associated with a newly received piece of selected attribute information and associated with all of the stored pieces of selected attribute information.

When the number of image IDs in the list A of image IDs is a given number or less, the image selecting unit 106 further obtains a list B of image IDs of images selected solely on the condition of the newly received piece of selected attribute information, and transmits at the very least the list A of image IDs and the list B of image IDs to the display sequence determining unit 107.

For example, when this is the case, first a priority display sequence of the images in the list A of image IDs is determined, then a priority display sequence of the images in the list B of image IDs is determined, and finally a sequence in which the priority display sequences are displayed consecutively is determined as a final priority display sequence. This is as an example of the determining method of the priority display sequence of the step S1506 by the display sequence determining unit 107.

It is to be noted that the group of images specified by the list A of image IDs is an example of the first group of images in regard to the image output device according to an aspect of the present invention, and the group of images specified by the list B of image IDs is an example of the second group of images in regard to the image output device according to an aspect of the present invention.

Moreover, the priority display sequence of the list A of image IDs is an example of the first display sequence in regard to the image output device according to an aspect of the present invention, and the priority display sequence of the list B of image IDs is an example of the second display sequence in regard to the image output device according to an aspect of the present invention.

(3) When one or more previously received pieces of selected attribute information are stored, the image selecting unit 106 obtains a list of image IDs for images associated with a newly received piece of selected attribute information and any of the one or more stored pieces of selected attribute information, and transmits at the very least the list of image IDs to the display sequence determining unit 107.

With the image display device 101 according to the fourth embodiment as described, the image output device 100 determines a piece of selected attribute information from input information obtained by a simple operation such as a user touching the display image in a specified location. The image output device can 100 further select and consecutively display images for priority display based on a plurality of pieces of selected attribute information when input information is received furthermore while operating in the priority display mode. This makes it possible for a group of images to be narrowed down even more to images which a user wishes to see and displayed. In other words, images to be displayed with priority can be selected efficiently.

It is to be noted that, according to the fourth embodiment, the case of images having both the subject name and the event information selected was described as such as an example. However, images can be selected by combined conditions based on a plurality of subject names, other attribute information described in the first, second, and third embodiments, or a combination thereof.

Moreover, the processing sequences according to the fourth embodiment shown in the flowchart (see FIG. 16) are not limited to the sequences shown in the flowchart in particular, and it goes without saying that the sequence of the steps may be rearranged as long as the same end result is achieved.

### Fifth Embodiment

The functional configuration of the image display device according to the fifth embodiment is the same as that of the image display device 101 and the image display device 1301 according to the first, second, and third embodiments, thus explanation thereof will be omitted.

It is to be noted that in the following explanation it is assumed that the image display device 101 according to the second embodiment is employed as the image display device of the fifth embodiment. Therefore, the characteristic operations of the image display device 101 according to the fifth embodiment will be explained.

The fifth embodiment will be explained while referring to FIG. 4 as an example of an image handled by the image display device 101, and to the data structures shown in FIG. 3 and FIG. 10.

Moreover, the image selecting unit 106 according to the fifth embodiment is the same as the image selecting unit 10 according to the fourth embodiment, and can store a piece of selected attribute information that is a received subject name or a piece of attribute information other than a subject name.

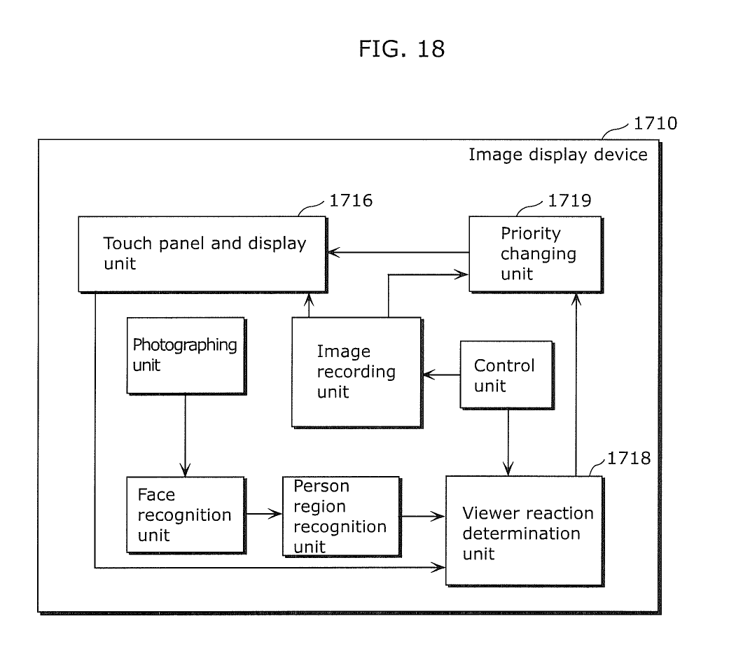

FIG. 17 is a flowchart which contains the processes condensed within the step “process determination of priority display sequence (S302)” shown in FIG. 8. Because other principle operations of the image display device 101 according to the fifth embodiment are the same as those in FIG. 7 and FIG. 8, those operations are referenced under the first embodiment. Only the processes executed by the image display device 101 according to the fifth embodiment shown in FIG. 17 will be explained.

The attribute information selecting unit 103 determines whether or not a cancellation action is included in the received input information or not (S1601). If a cancellation action is included (yes in S1601), step S1602 is performed. If a cancellation action is not included (no in S1601), step S1605 is performed.

It is to be noted that a cancellation action is a given action, such as a user touching an icon for cancellation on the touch panel display 105, or a user touching the same subject which was last touched again.

When a cancellation action is determined to be included in the received input information in step S1601, the attribute information selecting unit 103 confirms whether or not one or more pieces of selected attribute information are currently being stored (S1602). If one or more pieces of selected attribute information are being stored (yes in S1602), step S1603 is performed, and if one or more pieces of selected attribute information are not being stored (no in S1602), the priority display mode is ended.

When it is determined in step S1602 that one or more pieces of selected attribute information are stored, the attribute information selecting unit 103 deletes, from the one or more pieces of selected attribute information, the selected attribute information stored last (S1606).

After step S1606, the attribute information selecting unit 103 confirms whether or not one or more pieces of selected attribute information are currently being stored (S1604). If one or more pieces of selected attribute information are being stored (yes in S1604), step S1609 is performed, and if one or more pieces of selected attribute information are not being stored (no in S1604), the priority display mode is ended.

When a cancellation action is determined not to be included in the received input information in step S1601 (no in S1601), the attribute information selecting unit 103 compares the position information indicating a position on the display image included in the received input information with a subject position associated with the display image. When, according to the result of the comparison, the position indicated by the position information is within the region of the subject position (yes in S1605), step S1606 is performed. When the position indicated by the position information is outside the region of the subject position (no in S1605), step S1607 is performed.

The attribute information selecting unit 103 determines that the subject name corresponding to the subject position has been selected and transmits the subject name to the image selecting unit 106 when the position indicated by the position information is within the region of the subject position.

For example, when the image being displayed is the image with the image ID of 1 and the input position information is within the region of the subject position of the record 601, the attribute information selecting unit 103 transmits the subject name “Father” to the image selecting unit 106 as a piece of selected attribute information (S1606).

When the position indicated by the position information is outside the region of the subject position, the attribute information selecting unit 103 determines, by a given method, a piece of attribute information associated with the image being displayed to be a piece of selected attribute information, and transmits the selected attribute information to the image selecting unit 106, the attribute information being either the event information, the exposure date and time, or the shooting location information.

For example, when the image being displayed is the image with the image ID of 1 and the position indicated by the position information is outside any of the regions of the subject positions of the records 601, 602, or 603, the selected attribute information is determined from the record 901 shown in FIG. 10 (S1607). Methods of determining a piece of attribute information other than a subject name to be the selected attribute information are the same as the methods described in the second and third embodiments, thus explanation thereof will be omitted.

The image selecting unit 106 stores a received piece of selected attribute information (S1608). The selected attribute information may be stored in any location to which the image selecting unit 106 and the attribute information selecting unit 103 has access, including in the storage device 102 or in memory not shown in the drawings.

It is assumed that a plurality of pieces of selected attribute information exist as a result of a new piece of selected attribute information being stored in step S1608, or as a result of it being determined that a piece of selected attribute information is being stored in step S1604. In this case, the image selecting unit 106 obtains a list of image IDs of images associated with all of the pieces of selected attribute information and transmits at the very least the list of image IDs to the display sequence determining unit 107.

For example, when a piece of selected attribute information of the subject name “Father” and a piece of selected attribute information of the event information “2008 ski trip” are stored, a list of image IDs of images having both the subject name and the event information (“Father” and “2008 ski trip”), such as image IDs 1, 3, and 5, is obtained and transmitted (S1609).

It is to be noted that if only one piece of selected attribute information is stored, a list of image IDs based on that piece of selected attribute information is transmitted.

The display sequence determining unit 107 determines a priority display sequence by a given method on the basis of the received list of image IDs, and transmits at the very least the priority display sequence to the output unit 108 (S1610). The methods of determining the priority display sequence described in the first, second, and third embodiments may be used, thus explanation thereof will be omitted.

It is to be noted that a piece of attribute information of a subject name as well as a piece of attribute information other than a subject name stored in the image display device 101 are discarded upon completion of the priority display mode.

Moreover, the following additional examples for the step S1609 are conceivable, but are not limited thereby.

### [Processes for Selecting Images (S1609)]

(1) When one or more previously received pieces of selected attribute information are stored, the image selecting unit 106 obtains a list A of image IDs of images associated with a newly received piece of selected attribute information and associated with all of the stored pieces of selected attribute information.

When the number of image IDs in the list A of image IDs is a given number or less, the image selecting unit 106 further obtains a list B of image IDs of images selected solely on the condition of the newly received piece of selected attribute information. In other words, the image selecting unit 106 selects a plurality of images having attribute information which corresponds to the newly received selected attribute information, regardless of whether the plurality of images have attribute information which corresponds to the previously received selected attribute information or not. The image selecting unit 106 transmits at the very least the list B of image IDs to the display sequence determining unit 107.

(2) When one or more previously received pieces of selected attribute information are stored, the image selecting unit 106 obtains a list A of image IDs of images associated with a newly received piece of selected attribute information and associated with all of the stored pieces of selected attribute information.

When the number of image IDs in the list A of image IDs is a given number or less, the image selecting unit 106 further obtains a list B of image IDs of images selected solely on the condition of the newly received piece of selected attribute information, and transmits at the very least the list A of image IDs and the list B of image IDs to the display sequence determining unit 107.

For example, when this is the case, first a priority display sequence of the images in the list A of image IDs is determined, next a priority display sequence of the images in the list B of image IDs is determined, then a final priority display sequence of the priority display sequences being displayed consecutively is determined. This is as an example of the determining method of the priority display sequence of the step S1610 by the display sequence determining unit 107.

(3) When one or more previously received pieces of selected attribute information are stored, the image selecting unit 106 obtains a list of image IDs for images associated with a newly received piece of selected attribute information and associated with any of the one or more stored pieces of selected attribute information, and transmits at the very least the list of image IDs to the display sequence determining unit 107.

With the image display device 101 according to the fifth embodiment as described, the image output device 100 determines a piece of selected attribute information from input information obtained by a simple operation such as a user touching the display image in a specified location. The image output device 100 can further select and consecutively display images for priority display based on a plurality of pieces of selected attribute information when input information is received furthermore while operating in the priority display mode. Because the image output device can further cancel the selected attribute information last selected, images which the user wishes to see can be efficiently selected and displayed.

In other words, images to be displayed with priority can be selected efficiently with the image output device 100 according to the fifth embodiment.

It is to be noted that, according to the fifth embodiment, the case of images having both the subject name and the event information selected was described as such as an example. However, images can be selected by combined conditions based on a plurality of subject names, other attribute information described in the first, second, and third embodiments, or a combination thereof.

Moreover, the processing sequences according to the fifth embodiment shown in the flowchart (see FIG. 17) are not limited to the sequences shown in the flowchart in particular, and it goes without saying that the sequence of the steps may be rearranged as long as the same end result is achieved.

It is to be noted that, according to each of the embodiments, it is not necessary for the touch panel display 105 to be integrated with the image display device 101 or 1301, and it goes without saying that the touch panel display 105 being separated will produce the same results.

Moreover, according to each of the embodiments, it was written that attribute information is associated with an image, but attribute information may be associated with a subject captured within an image, and doing so will produce the same results.

Moreover, according to each of the embodiments, images handled by the image display device 101 or 1301 are not limited to still pictures; video may be handled as well.

Moreover, according to each of the embodiments, the input information acquisition unit 105b can be realized using a component other than the touch panel of the touch panel display 105. For example, the input information acquisition unit 105b can realized as an input device such as a keyboard or mouse.

It is to be noted that the present invention was explained based on the preceding embodiments, but it goes without saying that the present invention is not limited to these embodiments. The following cases are also to be included in the present invention.

(1) The preceding devices are a computer system configured of, specifically, a microprocessor, ROM (Read Only Memory), RAM (Random Access Memory), a hard disk unit, a display unit, a keyboard, and a mouse, for instance. A computer program is stored in the RAM or the hard disk unit. Each device achieves their function as a result of the microprocessor operating according to the computer program. Here, the computer program is configured of a plurality of pieced together instruction codes indicating a command to the computer in order to achieve a given function. It is to be noted that the devices are not limited to a computer system including, for example, each of a microprocessor, ROM, RAM, a hard disk unit, a display unit, a keyboard, and a mouse, and may be configured as a computer system including a portion of these components.

(2) A portion or all of the components of each of the preceding devices may be configured from one system LSI (Large Scale Integration). A system LSI is a super-multifunction LSI manufactured with a plurality of components integrated on a single chip, and is specifically a computer system configured of a microprocessor, ROM, and RAM, for example. A computer program is stored in the RAM. The system LSI achieves its function as a result of the microprocessor operating according to the computer program.

Moreover, each unit of the components configuring each of the preceding devices may be individually configured into single chips, or a portion or all of the units may be configured into a single chip.

Moreover, here the process is called a system LSI, but depending on the level of integration, the processes are also known as IC, LSI, super LSI, or ultra LSI. Moreover, the method of creating integrated circuits is not limited to LSI, but an integrate circuit may be realized as a specialized circuit or a general purpose processor. An FPGA (Field Programmable Gate Array) which allows post-manufacturing programming or a reconfigurable processor in which the connections and settings of a circuit cell in the LSI are reconfigurable may also be used.

Furthermore, if an integrated circuit technology comes about replacing LSI with the advancement in semiconductor technology or the launching of other technologies, of course that technology may also be used for integrating function blocks. As a potential application, biotechnology is also a possibility.

(3) A portion or all of the components of each of the preceding devices may each be configured from a detachable IC card or a stand-alone module. The IC card and the module are computer systems configured from a microprocessor, ROM, and RAM, for example. The IC card and the module may include the super-multifunction LSI described above. The IC card and the module achieve their function as a result of the microprocessor operating according to a computer program. The IC card and the module may be tamperproof.

(4) the present invention may be a method shown above. Moreover, the present invention may also be a computer program realizing these methods with a computer, or a digital signal of the computer program.

Moreover, the present invention may also be realized as the computer program or the digital signal stored on storage media readable by a computer, such as a flexible disk, hard disk, CD-ROM (Compact Disc), MO (Magneto-Optical disk), DVD (Digital Versatile Disc), DVD-ROM, DVD-RAM, DVD-RAM, BD (Blu-ray Disc), or a semiconductor memory. The present invention may also be the digital signal stored on the above mentioned storage media.

Moreover, the present invention may also be realized by transmitting the computer program or the digital signal, for example, via an electric communication line, a wireless or wired line, a network such as the internet, or data broadcasting.

Moreover, the present invention may be a computer system including memory storing the computer program and a microprocessor operating according to the computer program.

Moreover, the computer program or the digital signal may be implemented by an independent computer system by being stored on the storage media and transmitted, or sent via the network.

(5) The preceding embodiments and the preceding transformation examples may be individually combined.

### INDUSTRIAL APPLICABILITY

The image output device image and output method according to the present invention are useful as a device having a storage device and a means of display, and an image output method executed by the device, and can also be used for image display computer software.

Moreover, the image display device according to the present invention is, for example, useful as a digital photo frame for displaying a plurality of images.

### REFERENCE SIGNS LIST

100 image output device
101, 1301 image display device
102, 1302 storage device
103 attribute information selecting unit
104 receiving unit
105 touch panel display
105a display unit
105b input information acquisition unit
106 image selecting unit
107 display sequence determining unit
108 output unit
109 display control unit
110 display device
1310 ranking unit

1. An image output device for displaying a plurality of images consecutively, said image output device comprising:
a receiving unit configured to receive first input information which includes position information indicating a position on a display image that is an image displayed on a display device connected to said image output device;
an attribute information selecting unit configured to select, as first attribute information, one of a plurality of pieces of attribute information associated with the display image, the first attribute information corresponding to the position indicated by the position information;
an image selecting unit configured to select a plurality of images each having a piece of attribute information corresponding to the first attribute information from among a plurality of images including the display image stored in a storage device connected to said image output device;
a display sequence determining unit configured to determine a display sequence of the plurality of images selected by said image selecting unit based on the attribute information of each of the plurality of images; and
an output unit configured to obtain, from the storage device, the plurality of images selected by said image selecting unit and output the plurality of images such that the plurality of images are displayed on the display device in the display sequence determined by said display sequence determining unit.

2. The image output device according to claim 1,
wherein said receiving unit is further configured to receive second input information which includes position information indicating a position on the display image, the second input information being different in content from the first input information,
said attribute information selecting unit is further configured to select, as second attribute information, one of the plurality of pieces of attribute information associated with the display image, the second attribute information corresponding to the position information included in the second input information, and
said image selecting unit is configured to select, from among the plurality of images stored in the storage device, a plurality of images each having a piece of attribute information corresponding to the first attribute information and a piece of attribute information corresponding to the second attribute information.

3. The image output device according to claim 2,
wherein said image selecting unit is configured to select, from among a plurality of images stored in the storage device, a second group of images when after selecting a first group of images the number of images in the first group of images is a given number or less, the first group of images including a plurality of images each having a piece of attribute information corresponding to the first attribute information and a piece of attribute information corresponding to the second attribute information, and the second group of images including a plurality of images each having a piece of attribute information corresponding to the second attribute information.

4. The image output device according to claim 3,
wherein said display sequence determining unit is configured to determine a display sequence of the second group of images and skip the determination of the display sequence of the first group of images when the second group of images is selected by said image selecting unit, and
said output unit is configured to obtain, from the storage device, the plurality of images included in the second group of images selected by said image selecting unit and output the plurality of images such that the plurality of images are displayed on the display device in the display sequence determined by said display sequence determining unit.

5. The image output device according to claim 3,
wherein when the second group of images is selected by said image selecting unit, said display sequence determining unit is configured to (a) determine a first display sequence of the first group of images, (b) determine a second display sequence of the second group of images, and furthermore (c) determine a final display sequence which is a sequence of the first display sequence and the second display sequence, and
said output unit is configured to obtain, from the storage device, the plurality of images included in both the first group of images and the second group of images selected by said image selecting unit and output the plurality of images such that the plurality of images are displayed on the display device in the final display sequence.

6. The image output device according to claim 1,
wherein said display sequence determining unit is configured to determine the display sequence of the plurality of images selected by said image selecting unit based on the attribute information of each of the plurality of images which corresponds to the first attribute information.

7. The image output device according to claim 1,
wherein the first input information further includes action information indicating a type of action made upon input of the position information into said image output device, and
said attribute information selecting unit is configured to select the first attribute information from the plurality of pieces of attribute information associated with the display image, the first attribute information corresponding to the position information and the action information.

8. The image output device according to claim 1,
wherein the first input information further includes action information indicating a type of action made upon input of the position information into said image output device, and
said display sequence determining unit is configured to determine a display sequence of the plurality of images selected by said image selecting unit based on the attribute information of each of the plurality of images and the action information.

9. The image output device according to claim 1,
wherein said attribute information selecting unit is configured to obtain, from the storage device, information identifying a subject in the display image and information indicating a region on the display image corresponding to the subject, and configured to (a) select, as the first attribute information, attribute information specifying the subject when the position indicated by the position information is within the region, and (b) select, as the first attribute information, attribute information specifying a group the display image belongs to when the position indicated by the position information is outside the region.

10. An image display device that displays a plurality of images consecutively, said image display device comprising:
said image output device according to claim 1; and
the display device,
said display device including:
a display unit configured to receive and display the plurality of images output from said output unit in the display sequence determined by said display sequence determining unit; and
an input information acquisition unit configured to obtain the first input information by receiving a position on the display image, and transmit the obtained first input information which includes position information indicating the position to said receiving unit, the position being specified by a given action made on said image display device.

11. An image output method for displaying a plurality of images consecutively, said image output method comprising:
receiving first input information which includes position information indicating a position on a display image that is an image displayed on a display device;
selecting, as first attribute information, one of a plurality of pieces of attribute information associated with the display image, the first attribute information corresponding to the position indicated by the position information;
selecting a plurality of images each having a piece of attribute information corresponding to the first attribute information from among a plurality of images including the display image stored in a storage device;
determining a display sequence of the plurality of images selected by said image selecting unit based on the attribute information of each of the plurality of images; and
obtaining, from the storage device, the plurality of images selected by said image selecting unit and outputting the plurality of images such that the plurality of images are displayed on the display device in the display sequence determined by said display sequence determining unit.

12. An integrated circuit for displaying a plurality of images consecutively, said integrated circuit comprising:
a receiving unit configured to receive first input information which includes position information indicating a position on a display image that is an image displayed on a display device connected to said image output device;
an attribute information selecting unit configured to select, as first attribute information, one of a plurality of pieces of attribute information associated with the display image, the first attribute information corresponding to the position indicated by the position information;
an image selecting unit configured to select a plurality of images each having a piece of attribute information corresponding to the first attribute information from among a plurality of images including the display image stored in a storage device connected to said image output device;
a display sequence determining unit configured to determine a display sequence of the plurality of images selected by said image selecting unit based on the attribute information of each of the plurality of images; and
an output unit configured to obtain, from the storage device, the plurality of images selected by said image selecting unit and output the plurality of images such that the plurality of images are displayed on the display device in the display sequence determined by said display sequence determining unit.

13. A program for displaying a plurality of images consecutively recorded on a non-transitory computer-readable recording medium, said program causing a computer to execute:
receiving first input information which includes position information indicating a position on a display image that is an image displayed on a display device;
selecting, as first attribute information, one of a plurality of pieces of attribute information associated with the display image, the first attribute information corresponding to the position indicated by the position information;
selecting a plurality of images each having a piece of attribute information corresponding to the first attribute information from among a plurality of images including the display image stored in a storage device;
determining a display sequence of the plurality of images selected by said image selecting unit based on the attribute information of each of the plurality of images; and
obtaining, from the storage device, the plurality of images selected by said image selecting unit and outputting the plurality of images such that the plurality of images are displayed on the display device in the display sequence determined by said display sequence determining unit.
